(19) United States
(12) Patent Application Publication
(10) Pub. No.: US 2012/0151434 A1
(43) Pub. Date: Jun. 14, 2012

(54) System And Method For Generating One Or More Plain Text Source Code Files For Any Computer Language Representing Any Graphically Represented Business Process

(76) Inventor: Juan Ricardo Rivera Hoyos, Bogota (CO)

(21) Appl. No.: 13/324,673

(22) Filed: Dec. 13, 2011

Related U.S. Application Data
(60) Provisional application No. 61/422,937, filed on Dec. 14, 2010.

(51) Int. Cl. G06F 9/44

(52) U.S. Cl. 717/108

(57) ABSTRACT

The present invention is a system to generate plain text source code files involving a language representing a business process that includes a domain specific framework describing the business process with one or more points of view using one or more objects, a meta-model language that combines proprietary tags and computer instructions involving a specific solution domain and a code generator that uses the objects and files written in the meta-model language. The system also utilizes a method for generating plain text source code files involving any computer language representing a business process.

This application claims priority to U.S. Provisional Application 61/422,937 filed on Dec. 14, 2010, the entire disclosure of which is incorporated by reference.

### TECHNICAL FIELD & BACKGROUND

Corporate business processes are sophisticated, complex and unique entities depicting interactions of elements that represent how a company performs its operations and activities. Several approaches have been engaged by many individuals and organizations around the world regarding how to represent the way businesses perform their work. Many tools, standards and modeling techniques (i.e. business process modeling notation or BPMN) provide a fair but sometimes incomplete representation. A holistic business process representation must include a business process diagram and all of the elements that a company or individual must interact with. These elements must include one or more forms through which one or more users interact with data, one or more database expressions that perform CRUD (create, read, update and delete) operations with persistent information regarding one or more storage warehouses, one or more web services, one or more functions, one or more document repositories, one or more communications to be sent or received by one or more users, one or more reports and other entities. Once a business process is fully represented by such elements and one or more graphic blueprints of the dynamics of the business process, it must be implemented into usable software. Traditional software development processes require the support of computer engineers to convert the business representation into software. Such a conversion may be cumbersome and lengthy for even a small business process. And such conversion may be overwhelming for many businesses when faced with current technological day to day changes. One or more new devices, computer languages, software development tools and techniques are developed at a relatively faster rate making it difficult for even large corporations to stay updated.

The present invention allows a business to streamline a software development process by allowing a modeler to graphically describe one or more business process aspects of a given process and generate the source code of a computer software program that represents the business process.

For example, if a company needs to develop a computer program to select the most suitable or best quotation as part of a supply chain process, the created computer program's software must take into account the best prices, authorization levels and user requests among other suitable variables. Thousands of code lines are necessary to represent this process. The present invention allows a modeler to draw a diagram representing the business process that different users will interact with, define database interactions, create reports and in general specify and draw any other suitable objects needed for the process to be realized. These high level objects are taken from a pool of available objects in the object framework. The present invention will generate for a user in the computer language of their choice the software's source code. If the company needs to introduce any changes in the way they conduct their business, the modeler will update the process representation and generate a new set of source code files to accommodate those changes.

It is significant to note that neither a modeler nor end users need to have any knowledge of how to write computer language code in order to produce source code files for the different computer language platforms. A project's lifecycle, which involves identifying software requirements, modeling, writing code of a final product, deployment and documentation is dramatically reduced through the use of this invention compared to traditional software development process.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a block diagram of a system to generate one or more plain text source code files representing a graphically represented business process, in accordance with one embodiment of the present invention.

FIG. 2 illustrates a block diagram of an object framework of a system to generate one or more plain text source code files representing a graphically represented business process, in accordance with one embodiment of the present invention.

FIG. 3 illustrates a block diagram of one or more objects of an object framework of a system to generate one or more plain text source code files representing a graphically represented business process, in accordance with one embodiment of the present invention.

FIG. 4 illustrates an example of a set of one or more meta-model language files, in accordance with one embodiment of the present invention.

FIG. 5 illustrates a flowchart of a method for generating one or more plain text source code files representing a graphically represented business process code generator operation, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

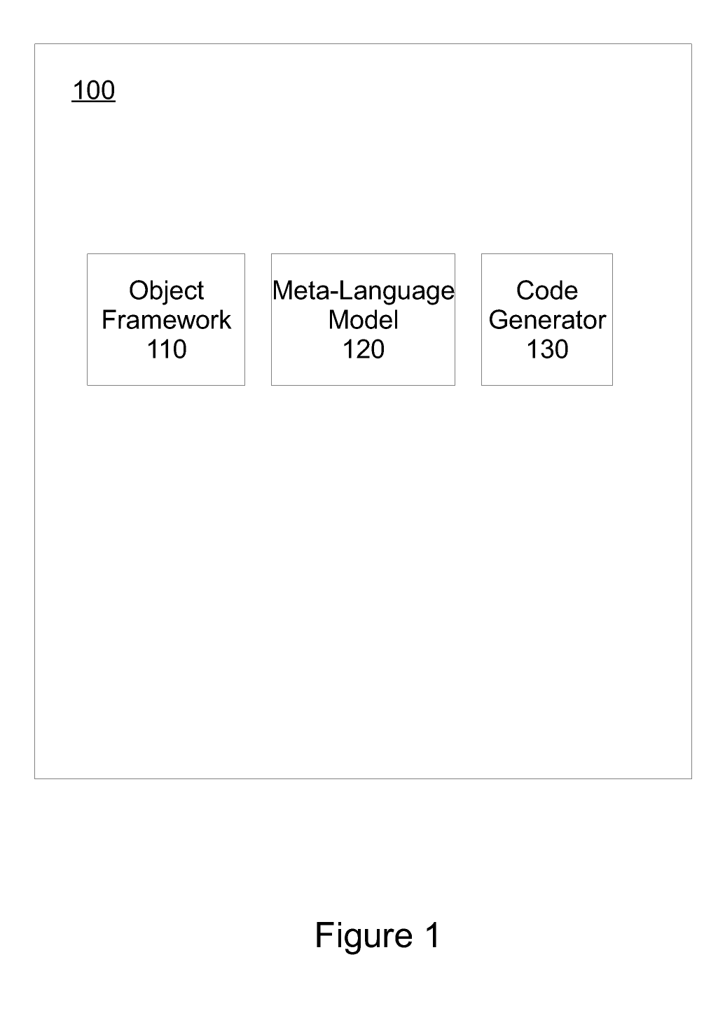

FIG. 1 illustrates a block diagram of a system 100 to generate one or more plain text source code files representing a graphically represented business process, in accordance with one embodiment of the present invention. Given a representation of a business process, the system 100 generates one or more source code of a software program that represents the graphically represented business process.

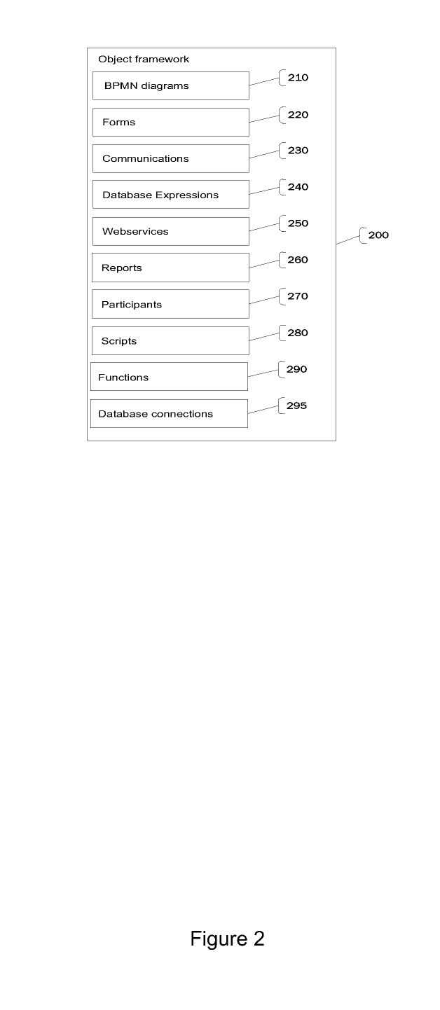

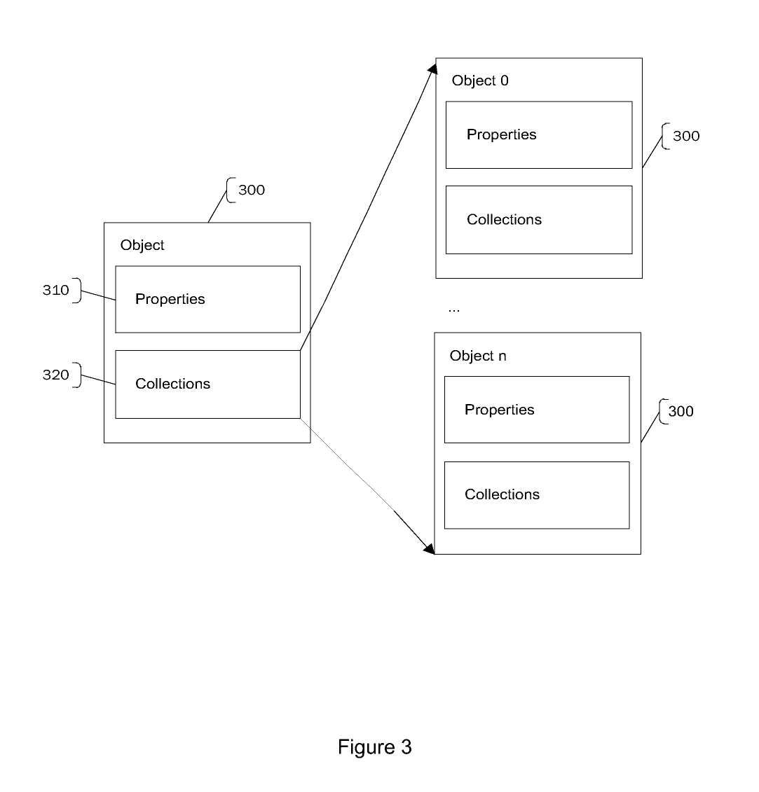

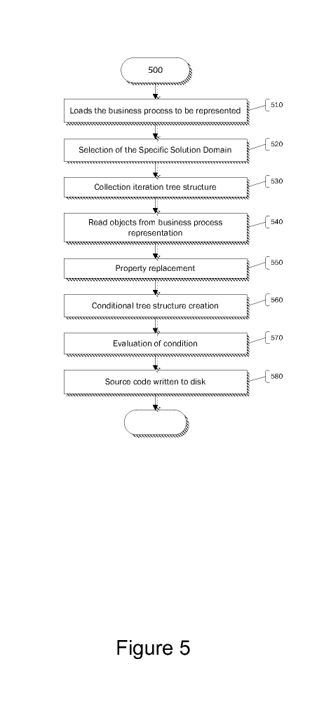

The system 100 includes an object framework 110, a meta-language model 120 and a code generator 130. The object framework 110 is a business process that can be described using one or more flowcharts, diagrams, forms, database expressions, reports, communications, web services, functions, scripts, document repositories and/or database connections. All these objects, their properties and their collections of objects are collectively known as the object framework 110 of the system. The object framework 110 is described in greater detail in FIG. 2 and its illustration and description. The meta-model language 120 is a language which is typically a computer language that combines one or more proprietary tags and computer instructions for a specific solution domain enabling software engineers to write one or more meta-model text files. A specific solution domain (SSD) is a domain where the represented process will be executed. A domain can be referred to as an architecture such as Microsoft Windows, Linux, Apple, Android or other suitable architecture, a computer language such as C#.net, java, Objective C, PHP, Symbian, TSQL, or any other suitable computer language, a device such as a smart phone handset, IPAD™, desktop computer or any other suitable device, a software development model such as client/server, web, standalone, web service, or any other suitable software development model or a specific set of human languages such as Spanish, English, French or any other suitable human language. The meta-language model 120 is described in greater detail in FIG. 3 and its illustration and description. The code generator 130 is an automated system that uses the object framework 110 objects and files written in the domain specific modeling language to produce the source code files. The code generator 130 is described in greater detail in FIG. 5 and its illustration and description.

FIG. 2 illustrates a block diagram of an object framework 200 of a system to generate one or more plain text source code files representing a graphically represented business process, in accordance with one embodiment of the present invention.

The object framework 200 includes one or more BPMN diagrams 210, one or more forms 220, one or more communications 230, one or more database expressions 240, one or more web services 250, one or more reports 260, one or more participants 270, one or more scripts 280, one or more functions 290 and one or more database connections 295. Other framework objects are not included for clarity in the diagram. Such objects include Document Repositories, Content Management, Hardware Integration, third party embedded objects among others.

The one or more BPMN diagrams 210 describe the dynamics of the activities, conditions, start, intermediate and end situations of the business process. The one or more forms 220 allows the one or more end users to interact with providing output of data to the user or as a way of inputting data to the system 100. The one or more communications 230 of the system can send to one or more end users. The one or more database expressions 240 are used to perform any type of CRUD (create, read, update and delete) operation on a database of the system 100 by an end user. The one or more web services 250 are web services that can be consumed by the end users. The one or more reports 260 can be any suitable type of report that provides information to the end user. The one or more participants 270 define the users, responsibilities and roles in the system 100. The one or more scripts 280 execute operations on objects and allow assignments of values between them. The one or more functions 290 also execute operations on objects and allow assignments of values between them. The one or more database connections 295 define the persistent data repositories such as one or more tables, relationships, columns, data, or other suitable repositories. A business process representation which may be composed of one or more of the objects in the object framework 200, illustrate the different views of a business process using one or more BPMN diagrams 210, one or more forms 220, one or more communications 230, one or more database expressions 240, one or more web services 250, one or more reports 260, one or more participants 270, one or more scripts 280, one or more functions 290 and one or more database connections 295 of the given business process, in contrast to just one view.

FIG. 3 illustrates a block diagram of one or more objects 300 of a system to generate one or more plain text source code files representing a graphically represented business process, in accordance with one embodiment of the present invention.

The objects 300 include one or more properties 310 and one or more collections 320. A generated source code that represents a given business process may contain information from different points of view. For example, a given business process can contain different diagrams and forms and will have properties 310 that define each business process distinctive one from another, such as the name of the product, the author, the date the source code was generated, or the company for which the product is created. Each point of view is modeled using Object Oriented Programming (OOP) methodologies. Thus, a business process that will undergo a code generation process can be composed of many different objects 300 (collections 320 of forms, reports and/or web services for example) and hold a distinctive set of properties 310 that fully describe the object. Each object may also be composed of collections 320 of objects 300 and a distinctive property set. For example, a BPMN Diagram object may contain many elements, each representing a BPMN object (start events, end events, tasks, etc.) and hold a distinctive set of properties 310 that the modeler can fill when representing the business process.

This hierarchy of objects 300 is the object framework 200. The system 100 relies on the object framework 200 as the origin of data that represents the business process or business processes and will be used during the code generation process to create a software system that represents the given business process or processes. The object framework 200 may grow in the future by allowing the creation of new points of view allowing the modeler improved and enhanced ways to express a process, but the OOP methodology used to create and incorporate these objects 300 in the object framework will remain unchanged enabling both the meta-model language and the code generator to read the object's framework.

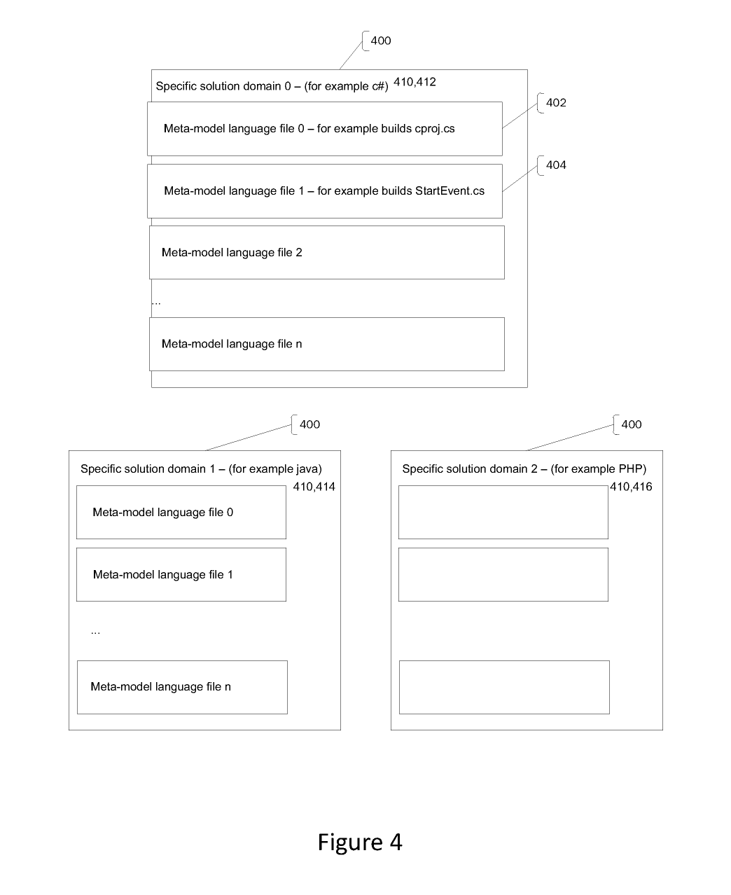

FIG. 4 illustrates an example of a set of one or more meta-model language files 400, in accordance with one embodiment of the present invention. The meta-model language files 400 are included individually in one or more specific solution domains 410. The meta-model language files 400 can build cproj.cs 402, StartEvents.cs 404 or any other suitable meta-model language file 400. The specific solution domains 410 can be C# 412, Java 414, PHP 416 or any other suitable specific solution domain.

The source code is any collection of statements or declarations written in some human-readable computer programming language. Source code is used by programmers to specify the actions to be performed by a computer. The source code which constitutes a program is usually held in one or more text files. Sometimes these text files are stored and compiled in databases as stored procedures. A large collection of source code files may be organized into a directory tree, in which case it may also be known as a source tree. A computer program's source code is the collection of files needed to convert from a human-readable form to some kind of a computer-executable form. The source code may be converted into an executable file by a compiler, or executed on the fly from the human readable form with the aid of an interpreter.

A meta-language allows computer engineers to write meta-model plain text files. These meta-model files along with a given process representation will be used by the code generator to produce the source code files of the software that represents the given process representation. The produced source code needs to be later compiled or interpreted for execution. The system and present invention does not compile or execute the generated source code. The meta-model files describe the behavior of each and all object framework objects for a specific solution domain (a specific computer language). All object framework objects are represented by sets of one or more meta-model files that contain the set of source code instructions that will be generated by the code generator for each specific arrangement of object framework elements (in other words each process representation). For each object framework object, a specific implementation (a specific set of meta-model files) must be written for each specific solution domain. Different sets of meta-model files will produce different source code files. Thus the system and present invention uses different sets of meta-model language files to produce source code for each specific solution domain.

Meta-model language files are written by combining:

object framework objects, their properties and their collections of objects;

instructions that can read the value of an object's property, iterate through collections of objects or determine actions or behaviors based upon the value of the properties of an object;

a set of functions and constants that facilitate documentation and final code tidiness during the code generation process; and

source code for a specific solution domain.

The meta-model language inspects the object framework using reflection (an object oriented programming tool) and exposes the objects, properties and collections available and combines these objects, properties and collections with available instructions enabling the meta-model file writer (normally a computer specialist) to write the sets of meta-model files.

The code generator is the component responsible of generating the plain text source code for any computer language given a process representation. Depending on the behavior each object has (defined using the meta-model files), the setting of its properties and collections and how it interacts with other objects, a distinctive software program representing the process will be created. The produced source code must be compiled or interpreted before generating a running software artifact.

FIG. 5 illustrates a flowchart of a method 500 for generating one or more plain text source code files representing a graphically represented business process code generator operation, in accordance with one embodiment of the present invention.

The method steps 500 include loading the business process to be represented 510, selecting a specific solution domain 520, collecting an iteration tree structure 530, reading one or more objects from the represented business process 540, replacing values of the object properties 550, creating a conditional tree structure 560, evaluating one or more condition sentences 570 and writing the generated source code to a storage medium 580.

The step of loading the business process to be represented 510 is performed by the code generator that produces the code representing the business process. The step of selecting a specific solution domain 520 involves the modeler to identify which set of meta-model language files will be used for the code generation process to allow the selection of the specific solution domain. The step of collecting an iteration tree structure 530 involves each meta-language file being parsed identifying first the instructions that iterate through collections, where a tree structure of such instructions is created. The step of reading one or more objects from the represented business process 540 involves starting from the outmost nodes and moving to the innermost nodes, where each tree node from the tree structure created in the previous step is analyzed. The object framework's object instance is read from the business process representation along with the values of each property and all instances of objects for each collection. The step of replacing values of the object properties 550 involves the code to be generated being parsed looking for properties that must be replaced by their values. The value of the properties is queried from the business process representation and replaced. The step of creating a conditional tree structure 560 involves each node in the tree structure being again parsed identifying any conditional sentences and a new conditional tree structure being created. The step of evaluating one or more condition sentences 570 involves each node in the conditional tree structure, being evaluated and the code to generate is either selected or discarded. The step of writing the generated source code to a storage medium 580 involves once all conditional statements, property replacements and collection iterations are complete, the code to be generated is written to a hard disk or other suitable storage media.

### Exhibit A. Meta-Model Language Syntaxis and Instructions

The meta-model language is a case sensitive, tag based syntax, domain specific meta-modeling language. The purpose of the tags is to facilitate parsing of the meta-model files during the code generation process and aid human reading of meta-model files.

### Instructions to Retrieve the Property of an Object

The meta-model language defines the following syntax to indicate the property of an object:

[[objectName.propertyName]]

During code generation, all properties of objects will be replaced by the value the modeler gave to each property during the business process representation.

Instructions that Iterate Through Collections of Objects

The meta-model language defines the following syntax to express iterations though a collection of objects.

[[foreach objName.collection in Collection]]

### Code to Generate

[[end foreach]]

This indicates that the code generation process will iterate (loop) one time for each object of type collection that exists in the object objName collection named Collection. Inside the statement, the user (normally a computer engineer) can write any desired text. During code generation, that text will be repeated as many times as instances of objects have the collection. The meta-model language defines a subset of instructions in the instructions that iterate through collections of objects. This instruction subset allows branching on first or last object in the collection.

The instruction [[ITERATOR_FOREACH]] can be used to identify the current iteration. This instruction will be replaced during code generation by the current iteration. Numbers will be zero-based and increase for each iteration.

The instruction [[TOTAL_NUMBER_OF_RECORDS_IN_FOREACH]] can be used to identify the total number of objects to be iterated. It will be replaced during code generation by the total number of objects to be iterated.

Instructions that Determine Actions or Behaviors Based upon the Value of the Properties of an Object

The instruction set for creating conditional code generation based upon the value of properties or collections are:

[[if objectName.PropertyName = “value”]]
CODE TO GENERATE
[[end if]]
[[if objectName.PropertyName != “value”]]
CODE TO GENERATE
[[end if]]
[[if objectName.PropertyName is in “value1,value2,value3”]]
CODE TO GENERATE
[[end if]]
[[if objectName.PropertyName is not in “value1,value2,value3”]]
CODE TO GENERATE
[[end if]]
[[if objectName has at least one collectionName.PropertyName = “value”]]
CODE TO GENERATE
[[end if]]
[[if objectName does not have at least one collectionName.PropertyName =
“value”]]
CODE TO GENERATE
[[end if]]
[[if objectName has no collectionName]]
CODE TO GENERATE
[[end if]]

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to generate one or more plain text source code files involving a language representing a business process, comprising:
a domain specific framework describing said business process with one or more points of view using one or more objects;
a meta-model language that combines one or more proprietary tags and computer instructions involving a specific solution domain; and
a code generator that uses said objects and files written in said meta-model language.

2. The system according to claim 1, wherein said points of view are modeled using object oriented programming (OOP) methodologies.

3. The system according to claim 1, wherein said objects include one or more flowcharts, one or more forms, one or more communications, one or more database expressions, one or more web services, one or more reports, one or more participants, one or more scripts, one or more document repositories, one or more functions and one or more database connections.

4. The system according to claim 3, wherein said flowcharts include business process modeling notation (BPMN) flowcharts.

5. The system according to claim 1, wherein said objects include one or more properties and one or more collections.

6. The system according to claim 1, wherein said computer instructions are source code involving said specific solution domain.

7. The system according to claim 6, wherein different sets of said meta-model language produces source code involving each said specific solution domain.

8. The system according to claim 6, wherein said each specific solution domain is written in a separate computer language.

9. The system according to claim 6, wherein said meta-model language describes behavior of said objects involving each said specific solution domain.

10. A computerized system that defines a domain specific modeling ecosystem involving a computer language representing a business process, comprising:
a domain specific framework describing said business process with one or more points of view using one or more objects;
a meta-model language that combines proprietary tags and computer instructions involving a specific solution domain; and
a code generator that uses said objects and files written in said meta-model language.

11. The system according to claim 10, wherein said points of view are modeled using object oriented programming (OOP) methodologies.

12. The system according to claim 10, wherein said objects include one or more flowcharts, one or more forms, one or more communications, one or more database expressions, one or more web services, one or more reports, one or more participants, one or more scripts, one or more document repositories, one or more functions and one or more database connections.

13. The system according to claim 12, wherein said flowcharts include business process modeling notation (BPMN) flowcharts.

14. The system according to claim 10, wherein said objects include one or more properties and one or more collections.

15. The system according to claim 10, wherein said computer instructions are source code involving said specific solution domain.

16. The system according to claim 15, wherein different sets of said meta-model language produces source code involving each said specific solution domain.

17. The system according to claim 15, wherein said each specific solution domain is written in a separate computer language.

18. The system according to claim 15, wherein said meta-model language describes behavior of said objects involving each said specific solution domain.

19. A method for generating plain text source code files involving a computer language representing a business process, comprising the steps of:
loading said business process to be represented;
selecting a specific solution domain;
collecting an iteration tree structure;
reading one or more objects from said represented business process;
replacing one or more values of said object properties;
creating a conditional tree structure;
evaluating one or more condition sentences; and
writing said generated source code to a storage medium.

20. The method according to claim 19, wherein said storage medium is a hard drive disk.
